(19) United States
(12) Patent Application Publication
(10) Pub. No.: US 2019/0176759 A1
(43) Pub. Date: Jun. 13, 2019

(54) METHOD AND APPARATUS FOR AUTOMATICALLY OPENING AN OBJECT

(71) Applicant: Continental Automotive GmbH, Hannover (DE)

(72) Inventors: Alexander Heinrich, Donaustauf (DE); Matthias Huschenbett, Regensburg (DE)

(21) Appl. No.: 16/196,058

(22) Filed: Nov. 20, 2018

(30) Foreign Application Priority Data
Dec. 11, 2017 (DE) 10 2017 222 392.8

(51) Int. Cl. B60R 25/24; G07C 9/00

(52) U.S. Cl. CPC B60R 25/245; G07C 9/00309; G07C 2009/00325; G07C 2209/63; G07C 2009/00769; G07C 2009/00555; G07C 2009/00547

(57) ABSTRACT

An apparatus for automatically opening or closing an object, wherein the apparatus has a control device and an electronic key, and wherein the control device is arranged in the object and is designed to check an authorization of an electronic key. The electronic key has at least one motion sensor which is designed to determine the movement of the electronic key, and the apparatus is designed to automatically open or close a door or flap of the object if the authorization of the electronic key has been determined and the electronic key has not moved for at least a first period.

### CROSS REFERENCE TO RELATED APPLICATIONS

This application claims priority to German Patent Application No. 10 2017 222 392.8, filed Dec. 11, 2017, the contents of such applications being incorporated by reference herein.

### FIELD OF THE INVENTION

The invention relates to a method and an apparatus for automatically opening an object.

### BACKGROUND OF THE INVENTION

Keyless vehicle entry and starting systems, such as the Passive Start Entry (PASE) system, for example, are automatic systems for unlocking a vehicle without active use of an automobile key and for starting said vehicle by merely operating the starting button. Vehicles in which the doors or a trunk lid or tailgate can additionally automatically open in particular situations are known. That is to say, neither a door handle nor a vehicle key needs to be actively actuated in order to open the vehicle. This can be advantageous, for example, if the user does not have a hand free to actively open a door or flap. Such an automatic hands-free system can have, for example, capacitive sensors in the vehicle which can detect a particular movement pattern of the user. For example, the user can carry out a particular movement (for example oscillating movement) in the vicinity of the sensor with a foot. If this movement is detected, the vehicle opens automatically. It is likewise possible for a door or flap of the vehicle to open automatically if a particular movement pattern of the electronic vehicle key relative to the vehicle is detected.

A movement pattern of the electronic vehicle key can be detected, for example, by carrying out a field strength measurement of signals which are transmitted between antennas arranged in the vehicle and the electronic vehicle key. In this case, the user's desire to automatically open a vehicle door cannot always be reliably detected in known systems. In addition, known systems are often comparatively expensive since many different components are required.

### SUMMARY OF THE INVENTION

An aspect of the invention is an apparatus and a method for opening an object which can be implemented as cost-effectively as possible and in which an opening desire of the user can be detected as reliably as possible.

An apparatus for automatically opening or closing an object has a control device and an electronic key. The control device is arranged in the object and is designed to check an authorization of an electronic key. The electronic key has at least one motion sensor which is designed to determine the movement of the electronic key. The apparatus is designed to automatically open or close a door or flap of the object if the authorization of the electronic key has been determined and the electronic key has not moved for at least a first period.

The standstill of the electronic key can be detected very reliably in this manner. In addition, such a system can be implemented in a cost-effective manner since few additional components are required.

The electronic key can have at least one antenna and can be designed to transmit at least one signal to the control device, wherein the at least one signal contains an item of information relating to the movement of the electronic vehicle key.

As a result, the control device in the object receives the information relating to the movement of the electronic key.

The electronic key can independently transmit the data to the control device. However, the electronic key can also be designed to emit the at least one signal in response to a request signal from the control device.

The motion sensor may have a MEMS sensor. Such sensors are often already used for other applications and can be concomitantly used to detect the standstill of the electronic key.

The motion sensor may have an acceleration sensor which is designed to detect accelerations in three spatial directions. The standstill of the electronic key can thus be detected very reliably.

The control device can also be designed to emit signals. The electronic key can receive these signals and can determine their reception field strengths. The apparatus can also be designed to determine, on the basis of the determined reception field strengths, whether the electronic key is moving. The detection of the standstill becomes even more reliable as a result.

The first period can be at least 1 s, at least 2 s, at least 3 s, at least 4 s or at least 5 s. An only short standstill may be random. By selecting the first period to be longer, it can be assumed in a more reliable manner that the standstill clearly expresses the user's wish to open or close a door of the object.

The motion sensor can also be designed to detect a movement of the electronic key after it has been detected that the electronic key has not moved for at least the first period, wherein the door or flap of the object can be automatically opened if it is detected that the electronic key carries out a predefined first movement, and the door or flap of the object can be automatically closed if it is detected that the electronic key carries out a predefined second movement which differs from the first movement.

As a result, the user can clearly specify to the system whether the door or flap is intended to be opened or closed. In some cases, this cannot be clearly detected if only the standstill of the electronic key is detected for a particular period.

The apparatus can be designed to output a signal as soon as a standstill of the electronic key has been detected. The user then has the possibility of aborting the process by carrying out a movement of the electronic key.

A method for automatically opening or closing an object comprises checking an authorization of an electronic key, determining, by means of a motion sensor in the electronic key, whether the electronic key is moving, and opening or closing a door or flap of the object if the authorization of the electronic key has been determined and it has been detected that the electronic key has not moved for at least a predefined period.

### BRIEF DESCRIPTION OF THE DRAWINGS

Aspects of the invention are explained in more detail below on the basis of the figures of the drawing, wherein like or similar elements are provided with the same reference signs. In the figures:

FIG. 1 shows an outline depiction of the principle of a system for automatically opening a vehicle,

FIG. 2 shows an outline depiction of the principle of a keyless vehicle entry and starting system,

FIG. 3 shows an outline depiction of various zones with respect to a vehicle having a system for automatically opening the vehicle,

FIG. 4 shows an outline depiction of a vehicle having a system for automatically opening a vehicle,

FIG. 5 shows a block diagram of a system for automatically opening an object according to one embodiment of the invention, and

FIG. 6 shows a flowchart of a method for automatically opening an object according to one embodiment of the invention.

### DETAILED DESCRIPTION OF THE PREFERRED EMBODIMENTS

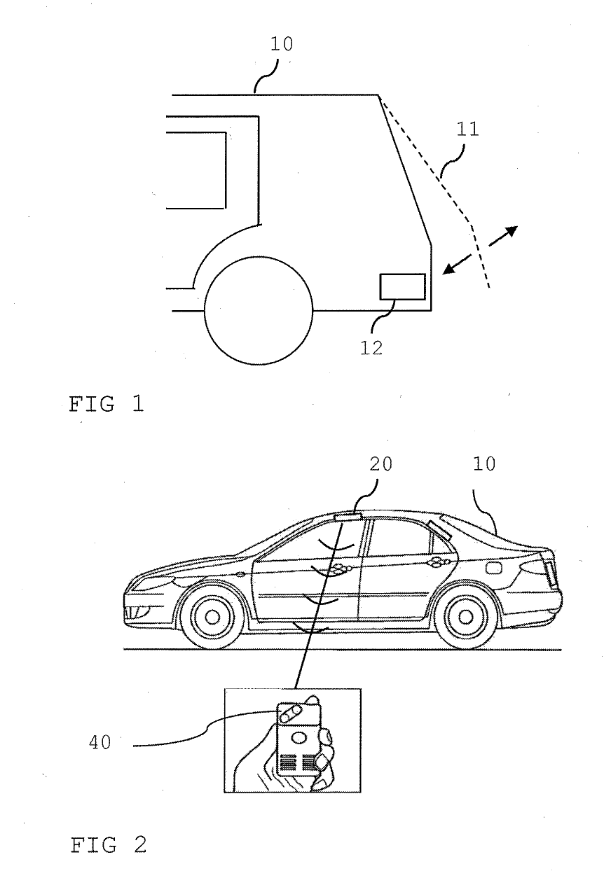

FIG. 1 shows a schematic depiction of a vehicle 10 having a tailgate 11. The tailgate 11 can be automatically opened and closed. Systems for automatically opening a vehicle door 11 can be implemented in various ways. In principle, the user communicates the desire to open a door or flap 11 of the vehicle 10 to the vehicle 10 in a predefined manner. If this desire is detected by the vehicle 10 or a corresponding control device 12 in the vehicle 10 and if the electronic vehicle key belonging to the vehicle 10 is within a particular range around the vehicle 10, the desired vehicle door or flap 11 is accordingly opened.

The desire to open the vehicle 10 can be communicated, for example, by virtue of the user carrying out a predefined movement. Such a movement can be carried out using the foot, for example. For example, an oscillating movement with the foot can be carried out in the capture range of a corresponding sensor. This may be, for example, a capacitive sensor or an optical sensor. A sensor can be arranged in the vicinity of the door or flap 11 to be opened, for example on the underside of the vehicle 10.

Instead of an individual short movement which could fundamentally also be carried out randomly without there being the desire to open a vehicle door 11, the performance of a more complex movement pattern (for example repeatedly moving the foot back and forward) can also be required to open the vehicle door 11. It is likewise possible to detect a movement pattern of the user relative to the vehicle 10. In this case, a movement of the vehicle key with respect to the vehicle 10 is usually determined, in particular, and the movement of the user carrying the vehicle key is inferred on the basis of this movement. For example, it may be necessary for the user to first of all move toward the vehicle 10 and to then move away from the vehicle again. In this case, the user can carry out substantially a V-shaped movement (seen from a bird's eye view). However, any other movements and/or movement patterns are possible. For example, it is also possible to carry out a W-shaped movement in which the user moves toward the vehicle and away again twice, wherein the movements are each carried out at a particular angle with respect to one another. Any other movement or any other movement pattern which can be easily and reliably detected is likewise possible in this case.

Such a movement of the user or of the vehicle key can be detected in various ways. For example, a position of the vehicle key relative to the vehicle 10 can be determined at different successive times. For example, a plurality of antennas arranged in the vehicle 10 can emit signals, for example LF signals (LF=Low Frequency). These signals are received by the vehicle key. The vehicle key can measure the reception field strength (RSSI) of each of the received signals. The reception field strength of a signal decreases with increasing distance from the transmission antenna. Since the position of the antennas in the vehicle 10 is known, the distance to the respective antennas and therefore the position of the vehicle key relative to the vehicle 10 can be determined on the basis of the reception signal strengths of two or more signals received at one time. If the measured reception field strength increases from measurement to measurement, this is an indication that the vehicle key is approaching the vehicle 10. Since the user carries the vehicle key, the position or movement of the vehicle key corresponds substantially to the position or movement of the user.

However, it may generally be the case that a user unintentionally carries out the predefined movement. For example, a user may not be familiar with the vehicle 10. This may be the case, for example, if the user has recently purchased the vehicle 10 or if the vehicle is a rental vehicle or a pool vehicle. In order to detect the user's desire to open a vehicle door or flap in an even clearer manner, it may be necessary, for example, for the user not to change his position for a predefined period. That is to say, the user must stay still in front of the vehicle door to be opened for a predefined period, for example. In this case, it is generally necessary for the user to carry out the predefined movement beforehand and to then stay still. In the simplest case, the predefined movement may involve the user moving toward the vehicle door to be opened. However, as described above, more complex movements or movement patterns are also possible.

FIG. 2 shows a schematic depiction of the fundamental principle of a keyless vehicle entry and starting system. A transmission unit 20 which is designed to emit signals is arranged in the vehicle 10. These are electromagnetic signals in the LF (Low Frequency) or HF (High Frequency) band, for example. These signals are received by an electronic vehicle key 40 when the latter is in the vicinity of the vehicle 10, and are subsequently evaluated and/or processed further. Following the evaluation and/or further processing in the electronic vehicle key 40, corresponding response signals can be transmitted back again to the transmission unit 20. The response signals are transmitted in the UHF frequency band, for example, and can be evaluated in the vehicle 10 by an evaluation unit which is not depicted in FIG. 2. The electronic vehicle key 40 may also be arranged, for example, in a portable electronic device which is carried by the user of the vehicle 10. Such a portable electronic device may be, for example, a smartphone, a tablet, a laptop, a PDA (Personal Digital Assistant) or the like. That is to say, the portable electronic device can assume the function of the vehicle key, for example by means of a corresponding application (app).

To receive the signals transmitted by the transmission unit 20, the electronic vehicle key 40 must be within a particular radius around the vehicle 10, since signals in the LF and HF bands have only a limited range. This radius may be 10 m, for example. This is merely an example, however. The range may also be greater or less. The transmission of a response signal from the electronic vehicle key 40 to the transmission unit 20 or to an evaluation unit in the vehicle 10 can be effected over a greater distance if the response signals are in the UHF frequency band, since these have a greater range.

The transmission unit 20 can emit signals continually or only in response to a particular event. Such an event may be the touching or actuation of a door handle, for example. However, systems which can detect whether the user is on the way back to his vehicle 10 using an application (app) installed on a smartphone belonging to the user on the basis of a movement pattern of the smartphone are also known. Any other suitable type of event is likewise possible. If the electronic vehicle key 40 transmits a correct response signal in response to a signal received from the transmission unit 20, the vehicle 10 is unlocked.

The corresponding door or flap 11 is automatically opened only when the electronic vehicle key 40 has been identified as belonging to the vehicle 10, that is to say the vehicle 10 has been unlocked, and the vehicle 10 also detects the user's desire to open a door or flap (that is to say a predefined movement or a movement pattern is detected, for example, and the electronic vehicle key then does not move for a predefined period).

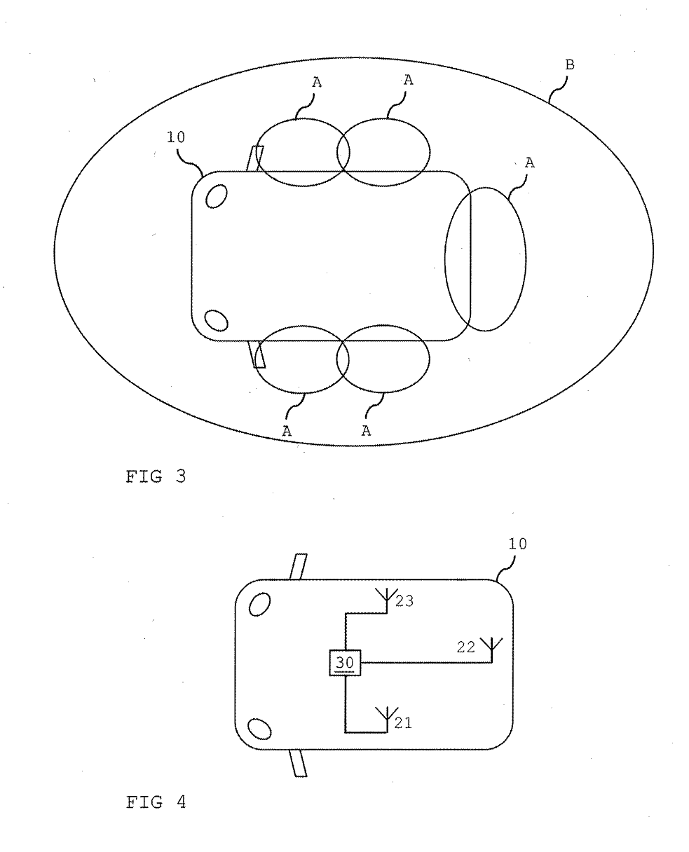

FIG. 3 shows a schematic depiction of a plan view of a vehicle 10. A zone A is respectively situated around the various vehicle doors and flaps. The number of zones A of a vehicle 10 depends, for example, on the number of doors and flaps, in particular on the number of doors and flaps which can be automatically opened. The number of zones A can furthermore also depend on the number of antennas arranged in the vehicle 10. In some vehicles, provision may be made, for example, for only the trunk lid to be able to be automatically opened. In this case, the other zones A around the further doors can be dispensed with. In other vehicles, the driver's door and/or other doors may possibly likewise be automatically opened.

So that the vehicle 10 can be unlocked, the user having the electronic vehicle key 40 must be within a reception range around the vehicle 10 or around the corresponding door or flap. The reception range B can extend in a particular radius around the entire vehicle 10, for example. In the example depicted in FIG. 3, a zone A is still in front of each vehicle door. If it is detected that the electronic vehicle key 40 is in one of the zones A, it can be inferred therefrom which of the doors is intended to be automatically opened. The shape and size of the respective zone A and of the reception range B depend, for example, on the number of antennas used, the arrangement of the antennas in the vehicle 10 and the signal strength of the emitted signals. The electronic vehicle key 40 can receive a request signal from the vehicle 10 and can then transmit back a (correct) response signal only when the electronic vehicle key 40 is within the reception range B. If the electronic vehicle key 40 is in the reception range B, but not in a zone A, it is inferred therefrom that none of the vehicle doors is intended to be automatically opened.

In order to detect in which of the zones A the vehicle key is situated, the reception field strength of antennas accordingly arranged in the vehicle can be determined and compared with predefined limit values.

In order to emit corresponding signals, the vehicle 10 can have one or more antennas 21, 22, 23. This is depicted by way of example in FIG. 4. A first antenna 21 can be arranged in the region of the driver's door, for example. A second antenna 22 can be arranged in the region of the tailgate and a third antenna 23 can be arranged in the region of the passenger door. This is merely an example, however. More or fewer antennas can be arranged at any desired suitable positions in the vehicle 10. The antennas 21, 22, 23 can be connected to a control device 30. The control device 30 can be designed to emit signals via one or more of the antennas 21, 22, 23. Signals received by the antennas 21, 22, 23 can in turn be transmitted to the control device 30 for further evaluation. The control device 30 can evaluate, for example, response signals which have been emitted by an electronic vehicle key 40 and have been received by at least one of the antennas 21, 22, 23. The response signals may contain information relating to the determined reception field strength.

In order to be able to clearly detect the user's desire to open a vehicle door, it may first of all be necessary, however, for the electronic vehicle key 40 or the user carrying the electronic vehicle key to carry out a predefined movement, for example. This has already been described further above with respect to FIG. 1. In the simplest case, the movement of the electronic vehicle key 40 may involve the key moving toward the vehicle 10 or the corresponding vehicle door. The fact that the electronic vehicle key 40 is moving toward the vehicle 10 can be detected, for example, from the fact that a response signal from the electronic vehicle key 40 is received in the vehicle 10 and the electronic vehicle key is identified as authorized. A predefined movement may likewise involve the electronic vehicle key 40 moving into a zone A. More complex movements are likewise possible, however. Following such a predefined movement, it may also be necessary for the electronic vehicle key 40 to not move for at least a particular period. That is to say, the user carrying the electronic vehicle key 40 must stay still for a predefined period.

In order to determine whether the electronic vehicle key 40 is moving, the position of the electronic vehicle key 40 with respect to the vehicle 10 can be determined at regular intervals, for example. The position of the user carrying the electronic vehicle key 40 can then be inferred from the position of the electronic vehicle key 40. One possible way of determining the position of the electronic vehicle key 40 with respect to the vehicle 10 involves measuring the reception field strengths of one or more signals emitted by the vehicle 10. In order to be able to reliably determine that the electronic vehicle key 40 has come to a standstill and does not move for a predefined period, a plurality of antennas 21, 22, 23 in the vehicle 10 are required for this purpose, however. If a field strength measurement is carried out only by means of one antenna in the vehicle 10, the standstill of the electronic vehicle key 40 may possibly not be reliably detected. For example, the user could move around the single antenna in a particular constant radius. Even though the user is not stationary, the same reception field strength is nevertheless measured in successive measurements in this case. This can be misinterpreted as a standstill. If the field strength measurement is carried out by means of a plurality of antennas, this measurement becomes more reliable. However, the costs of the system increase for each additional antenna in the vehicle 10.

How quickly the standstill of the electronic vehicle key 40 can be detected depends on the intervals at which signals are emitted by the vehicle 10 during the measurement of the reception field strength. The more frequently signals are emitted, the more quickly the standstill can be detected, but the higher the energy consumption also is in the vehicle 10 and in the electronic vehicle key 40. The more rarely signals are emitted, the later it can possibly be determined that the electronic vehicle key 40 has come to a standstill, but the lower the power consumption also is.

In order to be able to detect the standstill of the electronic vehicle key 40 in a more reliable manner, on the one hand, and more quickly, on the other hand, the movement of the electronic vehicle key 40 is detected according to an aspect of the present invention by means of at least one motion sensor 401 in the electronic vehicle key 40. Motion sensors 401 are already provided for other functions in many electronic vehicle keys 40. For example, some vehicle keys have motion sensors in order to be able to ward off so-called relay attacks. In this case, the vehicle key changes to a quiescent state if it has not moved for a predefined period. In the quiescent state, the vehicle key cannot receive any request signals from the vehicle 10 and/or cannot emit any response signals to the vehicle 10. That is to say, in the quiescent state, the vehicle key cannot be authenticated. If, for example, a smartphone acts as an electronic vehicle key 40, motion sensors 401 may already be provided for a wide variety of functions of the smartphone. These motion sensors can be concomitantly used to detect the standstill, with the result that no additional components are required and the system can be implemented in a cost-effective manner.

In the examples depicted, an aspect of the invention was described using the example of a vehicle 10. In principle, however, the system can also be arranged in any other object in order to automatically open a door, a flap, a gate or the like of the object, for example front doors, garage doors, etc. The vehicle may be an automobile. However, it is likewise possible for the vehicle to be a truck, a bus, a boat, an aircraft or any other vehicle.

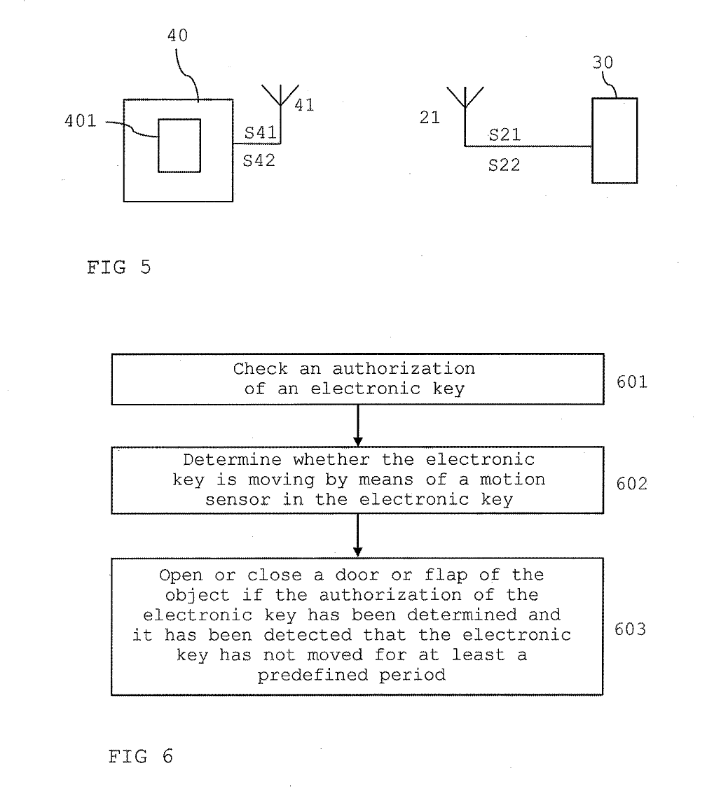

FIG. 5 schematically shows a system for automatically opening an object according to one embodiment of the invention. The system has a control device 30 and an electronic key 40. The control device 30 is designed to check an authorization of the electronic vehicle key 40. For this purpose, an electromagnetic signal S21 (request signal) can be emitted via an antenna 21. The signal S21 can be a signal in the LF band, for example. Signals in the LF band usually do not have a long range. For example, the range of such signals may be less than 10 m. The use of signals in the LF band is merely an example, however. Any other type of signals with a sufficient range can be used. FIG. 5 depicts one antenna 21 by way of example. This is merely an example, however. In principle, a number of n antennas can be used, where n≥1.

The electronic vehicle key 40 has a further antenna 41. The electromagnetic signal S21 can be received via this further antenna 41. The signal S21 can be evaluated in the electronic vehicle key 40. The electronic vehicle key 40 can then transmit a corresponding response signal S41 back to the control device 30. If the electronic vehicle key 40 is identified as belonging to the object on the basis of the response signal S41, the object can be unlocked.

The electronic vehicle key 40 also has a motion sensor 401. If it is detected that the electronic vehicle key 40 is in the vicinity of an object to be opened, the motion sensor 401 can be used to determine, for example, whether the electronic vehicle key 40 is moving or has come to a standstill. For example, if the control device 30 has received a valid response signal S41 from the electronic vehicle key 40, the control device 30 can query data from the motion sensor 401. The electronic vehicle key 40 can then transmit corresponding signals S42 to the control device 30, which signals contain information relating to whether or not the electronic vehicle key 40 is moving. Such signals S42 can be transmitted at regular intervals, for example. However, it is also possible for the electronic vehicle key to automatically emit the signals S42 with the movement data after it has received a request signal S21 from the control device 30.

The motion sensor 401 may have a MEMS (micro-electro-mechanical system) sensor, for example. For example, the motion sensor 401 may have an acceleration sensor which can capture accelerations and the intensity of accelerations in all three spatial directions. As a result, the motion sensor 401 can easily detect whether the electronic vehicle key 40 has come to a standstill and how long the standstill phase lasts. In this case, the standstill of the electronic vehicle key 40 can be detected very quickly. It is likewise possible to very quickly and reliably detect when the electronic vehicle key 40 moves again after a standstill.

The standstill of the electronic vehicle key 40 can be detected only by means of the motion sensor 401. However, it is also possible for the control device 30 to additionally emit further signals S22 via one or more antennas 21 in the vehicle 10 at regular intervals. The reception field strengths (RSSI) of these further signals S22 can then be determined in the electronic vehicle key 40. In principle, the electronic vehicle key 40 detects a greater reception field strength of a signal S22, the closer it is to the antenna 21. The determined value of the reception field strength is therefore dependent on the distance between the antenna 21 and the electronic vehicle key 40.

After the reception field strength of a signal S22 has been determined in the electronic vehicle key 40, the electronic vehicle key 40 emits a corresponding signal S42, for example, via the further antenna 41. This signal S42 is likewise an electromagnetic signal. In this case, the signal S42 contains an item of information relating to the respectively measured reception field strength. The control device 30 therefore receives the information relating to the measured reception field strengths and can determine the respective position of the electronic vehicle key 40 therefrom. However, it is also possible for the position to already be determined in the electronic vehicle key 40 and for the electronic vehicle key 40 to emit an item of information relating to the determined position in the signal S42.

The control device 30 can therefore additionally determine whether the electronic vehicle key 40 is moving or has come to a standstill on the basis of the determined positions of the electronic vehicle key 40. The data can be compared with the data provided by the motion sensor 401. The data provided by the motion sensor 401 can therefore be verified, for example. All positions in a particular radius around the antenna 21 have the same reception field strength, however. If one antenna is used, it is therefore only known that the electronic vehicle key 40 is somewhere on an arc with a particular radius around the corresponding antenna if the same reception field strength is determined for a plurality of successive signals S22. However, together with the data transmitted by the motion sensor 401, it is possible to clearly determine whether the user has come to a standstill. If it is detected that the user stays still for longer than for a predefined period, the corresponding door or flap of the vehicle 10 can be opened.

If the authorization of the vehicle key has therefore been determined and it is detected that the vehicle key has not moved for a predefined first period, the desired door or flap can be opened. For example, it may be necessary for the first period to be at least 1 s, 2 s, 3 s, 4 s or 5 s, that is to say the user stays still for at least 1 s, 2 s, 3 s, 4 s or 5 s, before the corresponding door is opened. In this case, it is also possible, for example, for the user to be informed as soon as the standstill has been detected. For example, an optical signal (for example flashing of the indicator lights), an acoustic signal (for example sounding of a horn) or a haptic signal (for example vibration of the electronic vehicle key) can be used to inform the user that a standstill has been detected. If the user wishes to open a door of the object, he can continue to stay still until he has not moved at least for the predefined first period and the opening desire has been detected. However, if the user would not like to open a door, he can abort the process by carrying out a movement after he has been informed of the detected standstill.

In the examples illustrated, the apparatus was described for the opening of doors. However, it is alternatively or additionally also possible to automatically close doors in the described manner. If the corresponding door is closed and the user stays still in a region in front of the door for at least the first period, the door can be opened. If the door is open and the user stays still in a region in front of the door for at least the first period, the door can be closed.

According to another example, the user can specify, for example, whether the corresponding door is intended to be opened or closed. For example, a vehicle or any other object could have a sliding door. The sliding door may not be completely closed, for example, but may not be completely open either. If the user stays still in a region around the door for at least the first period, the system does not know, for example, whether the user would like to completely open or completely close the door. As soon as he has stayed still at least for the first period and the desire to open or close the door has been detected, the user could then carry out a corresponding movement. For example, the user can move to the left in order to indicate that the door is intended to be closed. Alternatively, the user can move to the right in order to indicate that the door is intended to be opened. However, these are merely examples. The user can use any other movement to indicate whether the door can be opened or closed. In this case, sliding doors are merely an example. For any other type of doors or flaps, such a movement can also be used to determine whether said doors or flaps are intended to be opened or closed.

FIG. 6 shows a flowchart of a method for automatically opening an object according to one embodiment of the invention. In the method, an authorization of an electronic key is checked (step 601). Furthermore, a motion sensor in the electronic key is used to determine whether the electronic key is moving (step 602). A door or flap of the object is automatically opened if the authorization of the electronic key has been determined and it has been detected that the electronic vehicle key has not moved for at least a predefined period (step 603).

### LIST OF REFERENCE SIGNS

10 Vehicle
11 Tailgate
12 Control device
20 Transmission unit
21, 22, 23 Antennas
30 Control device
40 Electronic vehicle key
41 Antenna
401 Motion sensor
S21 Electromagnetic signal
S41, S42 Electromagnetic signal
A Reception range

1. An apparatus for automatically opening or closing an object, the apparatus comprising:
a control device, and
an electronic key, and wherein
the control device is arranged in the object and is designed to check an authorization of the electronic key;
the electronic key has at least one motion sensor which is designed to determine the movement of the electronic key; and
the apparatus is designed to automatically open or close a door or flap of the object if the authorization of the electronic key has been determined and the electronic key has not moved for at least a first time period.

2. The apparatus as claimed in claim 1, wherein the electronic key has at least one antenna and is designed to transmit at least one signal to the control device, wherein the at least one signal contains an item of information relating to the movement of the electronic vehicle key.

3. The apparatus as claimed in claim 2, wherein the electronic key is designed to emit the at least one signal in response to a request signal from the control device.

4. The apparatus as claimed in claim 1, wherein the motion sensor has a MEMS sensor.

5. The apparatus as claimed in claim 3, wherein the motion sensor has an acceleration sensor which is designed to detect accelerations in three spatial directions.

6. The apparatus as claimed in claim 1, wherein
the control device is also designed to emit signals;
the electronic key is designed to receive the signals and to determine their reception field strengths; and
the apparatus is also designed to determine, on the basis of the determined reception field strengths, whether the electronic key is moving.

7. The apparatus as claimed in claim 1, wherein the first time period is at least 1 s, at least 2 s, at least 3 s, at least 4 s or at least 5 s.

8. The apparatus as claimed in claim 1, wherein the motion sensor is also designed to detect a movement of the electronic key after it has been detected that the electronic key has not moved for at least the first time period, wherein
the door or flap of the object is automatically opened if it is detected that the electronic key carries out a predefined first movement; and
the door or flap of the object is automatically closed if it is detected that the electronic key carries out a predefined second movement which differs from the first movement.

9. The apparatus as claimed in claim 1, wherein the apparatus is designed to emit a signal as soon as a standstill of the electronic key has been detected.

10. A method for automatically opening or closing an object, wherein the method comprises:
checking an authorization of an electronic key;
determining, by means of a motion sensor in the electronic key, whether the electronic key is moving; and
opening or closing a door or flap of the object if the authorization of the electronic key has been determined and it has been detected that the electronic key has not moved for at least a predefined time period.

11. The apparatus as claimed in claim 4, wherein the motion sensor has an acceleration sensor which is designed to detect accelerations in three spatial directions.
